(19) United States
(12) Patent Application Publication
(10) Pub. No.: US 2024/0284371 A1
(43) Pub. Date: Aug. 22, 2024

(54) METHOD AND APPARATUS FOR ADJUSTING UPLINK TIMING

(71) Applicant: FUJITSU LIMITED, Kawasaki-shi Kanagawa (JP)

(72) Inventors: Meiyi JIA, Beijing (CN); Zhe CHEN, Beijing (CN); Xin WANG, Beijing (CN)

(73) Assignee: FUJITSU LIMITED, Kawasaki-shi Kanagawa (JP)

(21) Appl. No.: 18/637,352

(22) Filed: Apr. 16, 2024

Related U.S. Application Data
(63) Continuation of application No. PCT/CN2021/124803, filed on Oct. 19, 2021.

(51) Int. Cl. H04W 56/00; H04W 72/1268; H04W 72/232; H04W 76/20

(52) U.S. Cl. CPC H04W 56/0045; H04W 72/1268; H04W 72/232; H04W 76/20

(57) ABSTRACT

Embodiments of this disclosure provide a method and apparatus for adjusting uplink timing. The method includes: a terminal equipment obtains a first timing advance (TA) value that is pre-configured or predefined or configured by a network device; and the terminal equipment adjusts timing of first uplink transmission transmitted by the terminal equipment to the network device via an intermediate device (node/entity) by using the first TA value.

### CROSS-REFERENCE TO RELATED APPLICATION

This application is a continuation application of International Application PCT/CN2021/124803 filed on Oct. 19, 2021, and designated the U.S., the entire contents of which are incorporated herein by reference.

### FIELD

This disclosure relates to the field of communication technologies.

### BACKGROUND

In an existing uplink timing control mechanism, a network device determines an expected timing advance (TA) setting and provides it to a terminal equipment, and the terminal equipment uses the provided TA to determine its uplink transmission time relative to a downlink reception time observed by the terminal equipment, as shown in FIG. 1.

The network device may provide the TA to the terminal equipment via an MAC CE (media access control control element) command.

FIG. 2 is a schematic diagram of an MAC CE of a TA command. As shown in FIG. 2, a size of the MAC CE of the TA command is fixed, including one byte, wherein “TAG ID” indicates a TAG identifier of a TAG, including TAG identifier 0 used by a TAG of a special cell, with a length of 2 bits; in addition, “Timing Advance Command” indicates an index value TA (0, 1, 2, . . . , 63), which is used to control a timing adjustment amount to be applied by an MAC entity, with a length of 6 bits.

FIG. 3 is a schematic diagram of an MAC CE of an absolute TA command. As shown in FIG. 3, a size of the MAC CE of the absolute TA command is fixed, including two bytes.

In addition, in a random access procedure, a network device may provide TA to a terminal equipment via an MAC payload of an RAR (random access response) or MSGB (message B), wherein the random access procedure may be triggered by the following events:
initial access from RRC-IDLE;
an RRC connection reestablishment process;
arrival of DL or UL data during RRC-CONNECTED, when a UL synchronization state is “asynchronous”;
arrival of UL data during RRC-CONNECTED, when there is no available PUCCH resource for an SR;
an RRC request in synchronous reconfiguration (such as switching);
an RRC connection recovery process from RRC-INACTIVE;
time alignment for establishing a secondary TAG;
requests of other SIs;
beam failure recovery; and persistent UL LBT failure on a special cell.

Currently, two types of random access procedures are supported, namely, a 4-step RA type using MSG1 and a 2-step RA type using MSGA, both of which support contention-based random access (CBRA) and contention-free random access (CFRA).

FIG. 4 is a schematic diagram of random access procedures, showing four types of random access procedures, wherein, a) is CBRA with 4-step RA type, b) is CBRA with 2-step RA type, c) is CFRA with 4-step RA type, and d) is CFRA with 2-step RA type.

In initiating random access, based on network configuration, a terminal selects a random access type. For example, when no CFRA resource is configured, the terminal equipment selects a 2-step RA type or a 4-step RA type by using an RSRP threshold; when CFRA with 4-step RA type is configured, the terminal performs random access of 4-step RA type; and when CFRA with 2-step RAtype is configured, the terminal performs 2-step RAtype. The network will not configure CFRA resources for both 4-step RA type and 2-step RA type for a BWP. Moreover, CFRA with 2-step RA type only supports switching.

MSG1 of 4-step RA type includes a preamble on a PRACH. After MSG1 is transmitted, the terminal monitors a response from the network within a configured window. For CFRA, the network allocates a dedicated preamble for MSG1 transmission, and once the random access response is received from the network, the terminal terminates this random access procedure, as shown in c) of FIG. 4. For CBRA, when a random access response is received, the terminal transmits MSG3 by using a scheduled UL grant in the response and monitors a contention resolution, as shown in a) of FIG. 4; and if contention resolution is not successful after MSG3 is transmitted/retransmitted, the terminal goes back to MSG1 transmission.

MSGA of 2-step RA type includes a preamble on a PRACH and a payload on a PUSCH. After MSGA is transmitted, the terminal monitors a response from the network within a configured window. For CFRA, dedicated preamble and PUSCH resources for MSGA transmission are configured, and once the response of the network is received, the terminal terminates this random access procedure, as shown in d) of FIG. 4. For CBFA, if the contention resolution is successful when the response of the network is received, the terminal terminates the random access procedure, as shown in b) of FIG. 4; if a fallback indication is received in MSGB, the terminal executes MSG3 transmission and monitors contention resolution by using a scheduled UL grant in the fallback indication, as shown in FIG. 5; and if the contention resolution is not successful after MSG3 is transmitted/retransmitted, the terminal goes back to MSGA transmission.

If the random access procedure of 2-step RA type is not completed after multiple times of MSGA transmission, the terminal may be configured to be switched to 4-step RA type CBRA.

When CA is configured, 2-step RA type random access is only executed on a PCell, and contention resolution may be cross scheduled by the PCell.

When CA is configured, for random access procedure of a 4-step RA type, former 3 steps of CBRA always occur in the PCell, and contention resolution may be cross scheduled by the PCell. Three steps of CFRA starting at the PCell are all on the PCell. CFRA on an SCell is only initiated by a gNB, so as to establish timing advance for a secondary TAG: this procedure is initiated by the gNB in a PDCCH order (step 0) transmitted on a scheduling cell of an active SCell of the secondary TAG, and preamble transmission (step 1) occurs on this indicated SCell, while random access (step 2) occurs correspondingly on the PCell.

FIG. 6 is a schematic diagram of an MAC RAR, and FIG. 7 is a schematic diagram of a fallback RAR. It can be seen from FIGS. 6 and 7 that RARs of MAC and fallback are same. FIG. 8 is a schematic diagram of a success RAR. Reference may be made to relevant techniques for meanings of the parameters in FIGS. 6-8, which shall not be repeated herein any further.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in current NR (New Radio), operations of two TRPs are supported, in which two scenarios are included: 1) the two TRPs belong to a same cell; 2) the two TRPs belong to different cells, one of which is a serving cell, and the other is a cell with a different PCI. For scenario 1), the terminal uses identical TA values to perform uplink transmission with the two TRPs; and for scenario 2), no agreement has been made yet on whether to support identical or different TA values for cross-serving cell and TRPs with PCIs different from that of this serving cell. On the other hand, in a scenario of a repeater, whether a terminal communicates with a network device via the repeater is not distinguished, that is, uplink timing of reaching the network device via the repeater is identical to uplink timing of directly reaching the network device without the repeater.

Therefore, in a case of using operations of an additional node/device/entity (such as a TRP/repeater), existing techniques, i.e. performing uplink transmission by a terminal by using identical TA values, have the following problems: for data passing or not passing an additional node/device/entity, arrival times of data of identical/different terminals may be different, and a network device may possibly be unable to decode, thereby resulting in transmission errors, or that diversity gains are unable to be achieved.

In order to solve at least one of the above problems, embodiments of this disclosure provide a method and apparatus for adjusting uplink timing.

According to an aspect of the embodiments of this disclosure, there is provided an apparatus for adjusting uplink timing, configured in a terminal equipment, the apparatus including:
an obtaining unit configured to obtain a first timing advance (TA) value that is pre-configured or predefined or configured by a network device; and
an adjusting unit configured to adjust timing of first uplink transmission transmitted by the terminal equipment to the network device via an intermediate device (node/entity) by using the first TA value.

According to another aspect of the embodiments of this disclosure, there is provided an apparatus for adjusting uplink timing, configured in an intermediate device, the apparatus including:
an obtaining unit configured to obtain a fourth timing advance (TA) value that is pre-configured or predefined or configured by a network device; and
an adjusting unit configured to adjust timing of uplink transmission transmitted by the terminal equipment to the network device via the intermediate device by using the fourth TA value.

According to a further aspect of the embodiments of this disclosure, there is provided a communication system, including a terminal equipment, an intermediate device and a network device, wherein,
the terminal equipment is configured to obtain a first timing advance (TA) value that is pre-configured or predefined or configured by the network device, and adjust timing of first uplink transmission transmitted by the terminal equipment to the network device via the intermediate device (node/entity) by using the first TA value.

According to still another aspect of the embodiments of this disclosure, there is provided a communication system, including a terminal equipment, an intermediate device and a network device, wherein,
the intermediate device is configured to obtain a fourth timing advance (TA) value that is pre-configured or predefined or configured by a network device, and adjust timing of uplink transmission transmitted by the terminal equipment to the network device via the intermediate device by using the fourth TA value.

According to yet another aspect of the embodiments of this disclosure, there is provided a communication system, including a terminal equipment, an intermediate device and a network device, wherein,
the terminal equipment is configured to obtain a first timing advance (TA) value that is pre-configured or predefined or configured by the network device, and adjust timing of first uplink transmission transmitted by the terminal equipment to the network device via the intermediate device (node/entity) by using the first TA value;
and the intermediate device is configured to obtain a fourth timing advance (TA) value that is pre-configured or predefined or configured by a network device, and adjust timing of uplink transmission transmitted by the terminal equipment to the network device via the intermediate device by using the fourth TA value.

One of the advantages of the embodiments of this disclosure exists in that in the case of using operations of an additional node/device/entity, though the method and apparatus for adjusting uplink timing provided in the embodiments of this disclosure, times for uplink data from identical/different terminals that pass or do not pass the additional node/device/entity to reach the network device are identical or time difference therebetween is tolerable, hence, the network device is able to decode successfully and diversity gains may be achieved. In addition, times for uplink data from identical/different terminals to reach the additional node/device/entity are identical or a time difference therebetween is tolerable, hence, the additional node/device/entity may perform signal processing successfully, and transmit signals to the network device, thereby achieving uplink coverage enhancement.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/includes” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of an uplink and downlink timing relationship;

FIG. 2 is a schematic diagram of an MAC CE of a TA command;

FIG. 3 is a schematic diagram of an MAC CE of an absolute TA command;

FIG. 4 is a schematic diagram of a random access procedure;

FIG. 5 is a schematic diagram of fallback of CBRF with 2-step RA type;

FIG. 6 is a schematic diagram of an MAC RAR;

FIG. 7 is a schematic diagram of a fallback RAR;

FIG. 8 is a schematic diagram of a success RAR;

FIG. 9 is a schematic diagram of a deployment scenario of a repeater/RIS;

FIG. 10 is a schematic diagram of multi-TRP operations;

FIG. 11 is a schematic diagram of the method for adjusting uplink timing of an embodiment of this disclosure;

FIG. 12 is a schematic diagram of an example of an MAC CE providing TA;

FIG. 13 is a schematic diagram of another example of an MAC CE providing TA;

FIG. 14 is a schematic diagram of a further example of an MAC CE providing TA;

FIG. 15 is a schematic diagram of an example of a BWP-like TRP/SR/RIS model;

FIG. 16 is a schematic diagram of an example of a cell-like TRP/SR/RIS model;

FIG. 17 is a schematic diagram of an addition config-like TRP/SR/RIS model;

FIG. 18 is a schematic diagram of the method for adjusting uplink timing of an embodiment of this disclosure;

FIG. 19 is a schematic diagram of the method for adjusting uplink timing of an embodiment of this disclosure;

FIG. 20 is a schematic diagram of the apparatus for adjusting uplink timing of an embodiment of this disclosure;

FIG. 21 is a schematic diagram of the apparatus for adjusting uplink timing of an embodiment of this disclosure;

FIG. 22 is a schematic diagram of the apparatus for adjusting uplink timing of an embodiment of this disclosure;

FIG. 23 is a schematic diagram of the communication system of an embodiment of this disclosure;

FIG. 24 is a schematic diagram of the terminal equipment of an embodiment of this disclosure;

FIG. 25 is a schematic diagram of the intermediate device of an embodiment of this disclosure; and

FIG. 26 is a schematic diagram of the network device of an embodiment of this disclosure.

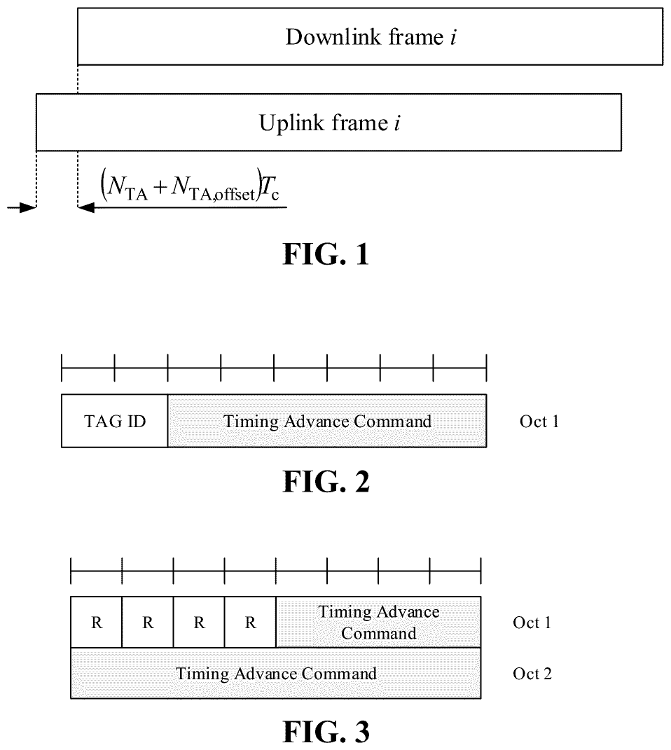

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), and an IAB (integrated access and backhaul) node or an IAB-DU or an IAB-donor. The term “base station” may include some or all of its functions, and each base station may provide communication coverage for a specific geographical area. And a term “cell” may refer to a base station and/or its coverage area, depending on a context of the term. Without causing confusion, the terms “cell” and “base station” are interchangeable.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above. Unless otherwise specified in this text, “device” may refer to a network device, or may refer to a terminal equipment.

In an existing communication system, in order to increase coverage, an additional node/device/entity is added between a network device (such as a gNB or a gNB-CU) and a terminal, which has a simplified protocol stack/function for processing (such as amplifying, and routing, etc.) signals/symbols received from the network device and transferring them to the terminal. The additional node/device/entity may be a repeater/RIS (reconfigurable intelligent surface), or may be a TRP, etc. For the convenience of explanation, in the embodiments of this disclosure, the additional nodes/devices/entities are collectively referred to as intermediate devices. However, this disclosure is not limited thereto, and all scenarios where an additional node/device/entity is/are used between the network device and the terminal are scenarios of the embodiments of this disclosure.

Scenarios of the embodiments of this disclosure shall be described below by way of examples; however, this disclosure is not limited thereto.

FIG. 9 is a schematic diagram of a deployment scenario of a repeater/RIS. As shown in FIG. 9, the repeater/RIS is a device that receives, processes and transmits radiated or conducted RF carriers in a downlink direction (from a network device BS to a terminal UE) and an uplink direction (from the terminal UE to the network device BS). For the repeater, the processing includes power amplifying; and for the RIS, the processing includes beamforming, reshaping a propagation environment, etc. In a working frequency band where only downlink or uplink is designated, only transmission of the designated uplink or downlink is repeated.

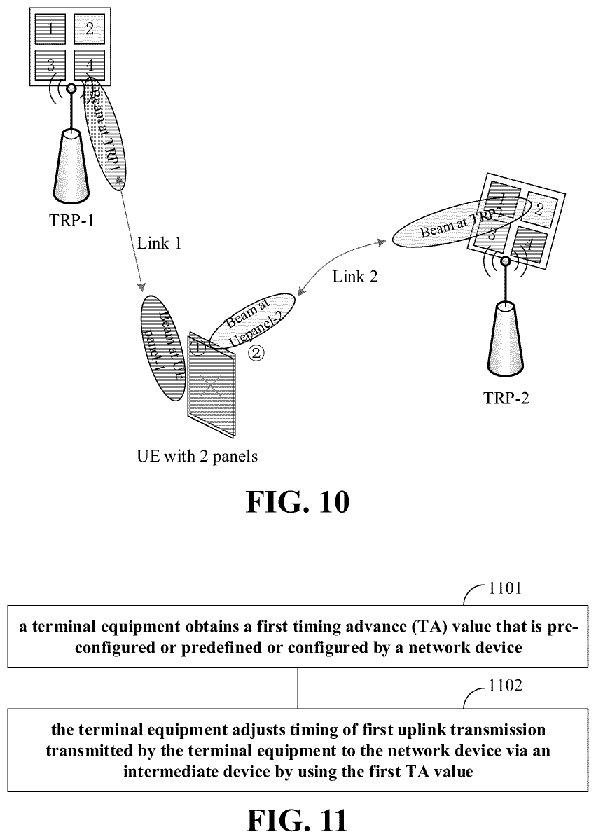

FIG. 10 is a schematic diagram of multi-TRP operations. A TRP is a part of a network device and is used to receive signals from or transmit signals to a terminal UE.

As shown in FIG. 10, in multi-TRP operations, one serving cell may schedule the UE from two TRPs, provide better PDSCH coverage, reliability and/or data rates. For multi-TRP, there are two different operating modes, namely, single-DCI and multi-DCI. For these two modes, within configuration provided by an RRC layer, control of uplink and downlink operations is performed by a physical layer and an MAC layer. In the single-DCI mode, the UE is scheduled by two TRPs via identical DCI, and in the multi-DCI mode, the UE is scheduled by individual DCI of each TRP. These two TRPs may belong to identical cells or different cells.

As shown in FIG. 10, a gNB where TRP-2 is located is an additional node/device/entity, while a gNB where TRP-1 is located is a network device. TRP-2 and TRP-1 may belong to (different cells of) different gNBs, and the two may exchange information via an X2 interface; or, TRP-2 and TRP-1 may be parts of a gNB, belong to (identical or different cells) of identical gNB, and exchange information via an internal interface.

The embodiments of this disclosure shall be described below with reference to the accompanying drawings and implementations, and identical expressions therein having identical meanings, which shall not be repeated herein any further.

### Embodiment of a First Aspect

The embodiment of this disclosure provides a method for adjusting uplink timing, which shall be described from a terminal equipment.

FIG. 11 is a schematic diagram of the method for adjusting uplink timing of the embodiment of this disclosure. As shown in FIG. 11, the method includes:
1101: a terminal equipment obtains a first timing advance (TA) value that is pre-configured or predefined or configured by a network device; and
1102: the terminal equipment adjusts timing of first uplink transmission transmitted by the terminal equipment to the network device via an intermediate device by using the first TA value.

It should be noted that FIG. 11 only schematically illustrates the embodiment of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 11.

In the above embodiment, the first TA value is used by the terminal equipment to adjust the timing of the uplink transmission transmitted by the terminal equipment to the network device via the intermediate device, so that times for the uplink data from identical/different terminal equipments that pass/do not pass an intermediate device to reach the network device are identical or a time difference therebetween is tolerable, thereby solving the problem that the network device is able to decode.

In some embodiments, the terminal equipment may further obtain a second timing advance (TA) value that is pre-configured or predefined or configured by the network device, and adjust timing of second uplink transmission transmitted by the terminal equipment to the network device by using the second TA value.

In the above embodiment, the second TA value is used by the terminal equipment to adjust timing of uplink transmission directly from the terminal equipment to the network device without via an intermediate device, so that times for data from identical/different terminal equipments that do not pass an intermediate device to reach the network device are identical or a time difference therebetween is tolerable, thereby solving the problem that the network device is able to decode.

In the above embodiment, the first uplink transmission and the second uplink transmission respectively include one of a PUCCH, a PUSCH and an SRS or any combination thereof. However, this disclosure is not limited thereto, and the first uplink transmission and the second uplink transmission may also include other channels or signals, respectively, which shall not be described herein any further.

In the above embodiment, the terminal equipment may transmit the first uplink transmission based on the first TA value, and the first uplink transmission is forwarded by the intermediate device to the network device.

In the above embodiment, the terminal equipment determines a transmission time of the first uplink transmission relative to a downlink reception time observed by the terminal equipment or relative to a last uplink transmission time of the terminal equipment, by using the provided TA.

In the above embodiment, the network device may further configure a TA value (referred to as a third TA value) for the intermediate device, the terminal equipment may transmit the first uplink transmission based on the first TA value, and the first uplink transmission is transmitted by the intermediate device to the network device based on the above third TA value.

In the above embodiment, the intermediate device determines the transmission time of the first uplink transmission relative to the downlink reception time observed by the intermediate device or relative to an uplink transmission time of the intermediate device, by using the provided TA.

The terminal equipment adjusting the timing of transmitting the first uplink transmission transmitted by the terminal equipment to the network device via the intermediate device by using the first TA value shall be described below in detail.

In some embodiments, after the network device activates the intermediate device, the terminal equipment adjusts the timing of the first uplink transmission transmitted from the terminal equipment to the network device via the intermediate device by using the first TA value. The first uplink transmission is, for example, an SRS, or a PUCCH.

In the above embodiment, the terminal equipment may receive an activation indication for activating the intermediate device transmitted by the network device.

In the above embodiment, the activation indication may be downlink control information (DCI), or a media access control (MAC) control element (CE), or a combination of DCI and an MAC CE, and this disclosure is not limited thereto. The activation indication may include transmission configuration indication (TCI) state information and/or a control resource set pool identifier (CORSET pool ID) to which the intermediate device corresponds.

The TCI state information may be unified, that is, it is applicable to uplink (UL) and downlink (DL), applicable to all channels, and is applicable to two modes, namely single DCI (SDCI) and multiple DCI (MDCI); however, this disclosure is not limited thereto, and the TCI state may also be only applicable to either one of uplink or downlink, and is only applicable to one type channel; for example, a PDCCH and a PDSCH use different TCI state information, and are applicable to only one mode, for example, the MDCI may use a CORSET pool ID, but the SDCI may not.

For example, the TCI state information may be a TCI state ID used to indicate TCI state information of a PDCCH, and an included TCI state ID indicates that a corresponding TCI state is active. Or, the TCI state information may also be Ti used to indicate TCI state information of a PDSCH, where, i corresponds to a TCI state ID, a value of 1 thereof indicating that a corresponding TCI state is active.

In some embodiments, after the network device activates the intermediate device and initializes or re-initializes a configured UL grant, the terminal equipment adjusts the timing of the first uplink transmission on the configured UL grant transmitted from the terminal equipment to the network device via the intermediate device by using the above first TA value. The first uplink transmission on the configured UL grant is, for example, PUSCH transmission.

In the above embodiment, the terminal equipment may receive an activation indication for activating the intermediate device transmitted by the network device, and adjust the timing of the first uplink transmission transmitted from the terminal equipment to the network device via the intermediate device by using the above first TA value after the configured UL grant is initialized or reinitialized. The above activation indication has been described above, which shall not be repeated herein any further.

In the above embodiment, the configured UL grant includes: an uplink grant provided by RRC, and an uplink grant provided by a PDCCH, etc. The uplink grant provided by the PDCCH refers to that RRC provides uplink grant configuration information, and the PDCCH activates or deactivates a corresponding uplink grant.

In some embodiments, after the network device activates the intermediate device and after SRS configuration is recovered, the terminal equipment adjusts the timing of the first uplink transmission (SRS) corresponding to the SRS configuration transmitted from the terminal equipment to the network device via the intermediate device by using the above first TA value.

In the above embodiment, the terminal equipment may receive an activation indication for activating the intermediate device transmitted by the network device, and after SRS configuration is recovered, the terminal equipment adjusts the timing of the first uplink transmission transmitted from the terminal equipment to the network device via the intermediate device by using the above first TA value. The above activation indication has been described above, which shall not be repeated herein any further.

In some embodiments, after the network device activates the intermediate device, the terminal equipment may recover or transmit a PUCCH, and adjust the timing of the first uplink transmission on the PUCCH transmitted from the terminal equipment to the network device via the intermediate device by using the above first TA value.

In the above embodiment, the terminal equipment may receive the activation indication for activating the intermediate device transmitted by the network device, recover or transmit the PUCCH, and adjust the timing of the first uplink transmission transmitted from the terminal equipment to the network device via the intermediate device by using the above first TA value. The above activation indication has been described above, which shall not be repeated herein any further.

In some embodiments, after the network device activates the above intermediate device and after the terminal equipment receives a scheduling indication for the first uplink transmission from the network device, the terminal equipment adjusts the timing of the first uplink transmission transmitted from the terminal equipment to the network device via the intermediate device by using the above first TA value. The first uplink transmission is, for example, PUSCH transmission.

In the above embodiment, the terminal equipment may receive the activation indication for activating the intermediate device transmitted by the network device, may also receive a scheduling indication for scheduling the first uplink transmission transmitted by the network device, and upon receiving the scheduling indication, adjusts the timing of the first uplink transmission transmitted from the terminal equipment to the network device via the intermediate device by using the above first TA value. The above activation indication has been described above, which shall not be repeated herein any further.

In the above embodiment, the scheduling indication is downlink control information, such as DCI format 0-0 or DCI format 0-1 or DCI format 0-2. In addition, the scheduling indication includes a TCI state ID and/or a CORSET pool ID.

For DCI format 0-0 using a C-RNTI or a CS-RNTI or an MCS-RNTI for CRC scrambling, or for DCI format 0-1 using a C-RNTI or a CS-RNTI or an SP-CSI-RNTI or an MCS-C-RNTI for CRC scrambling, or for DCI format 0-2 using a C-RNTI or a CS-RNTI or an SP-CSI-RNTI or an MCS-C-RNTI for CRC scrambling, 7 bits may be added to the DCI to indicate the TCI state ID, and/or 1 bit may be added to the DCI to indicate the corset pool ID.

In addition, for DCI format 0-0 using a TC-RNTI for CRC scrambling, reserved 1 bit (new data indicator) in DCI may be used to indicate the corset pool ID, and/or 7 bits may be added to the DCI to indicate the TCI state ID.

In some embodiments, after receiving the scheduling indication for the first uplink transmission from the network device, the terminal equipment adjusts the timing of the first uplink transmission transmitted from the terminal equipment to the network device via the intermediate device by using the first TA value.

In the above embodiment, the intermediate device may be in a default active state, or may be in an inactive state. In the inactive state, the terminal equipment may first activate the intermediate device, and then adjusts the above timing.

In the above embodiment, the terminal equipment may receive the scheduling indication for scheduling the first uplink transmission transmitted by the network device, and upon receiving the scheduling indication, adjusts the timing of the first uplink transmission transmitted from the terminal equipment to the network device via the intermediate device by using the first TA value.

In the above embodiment, the scheduling indication may be downlink control information (DCI); however, this disclosure is not limited thereto. In addition, the scheduling indication may include a transmission configuration indication (TCI) state identifier (TCI state ID) and/or a control resource set pool identifier (CORSET pool ID) to which the intermediate device corresponds. Contents of the scheduling indication have been described above, which shall not be described herein any further.

In some embodiments, the above intermediate device is autonomously activated by the terminal equipment. In a case where the intermediate device is activated, the terminal equipment adjusts the timing of the first uplink transmission transmitted from the terminal equipment to the network device via the intermediate device by using the first TA value.

In the above embodiment, the terminal equipment may determine whether to activate the intermediate device, and in a case where the intermediate device is activated, the terminal equipment adjusts the timing of the first uplink transmission transmitted from the terminal equipment to the network device via the intermediate device by using the first TA value.

In the above embodiment, the terminal equipment may determine whether to activate the intermediate device based on measurement results of a downlink reference signal from the network device and/or a downlink reference signal from the network device and via the intermediate device and/or a downlink reference signal from the intermediate device.

In the above embodiment, the terminal equipment may also determine whether to activate the intermediate device based on a result of beam failure detection between it and the network device or based on whether to trigger beam failure recovery between it and the network device.

The above two methods for determining whether to activate the intermediate device are illustrative only, and the two methods may be implemented separately, or may be implemented in a combined manner, which are not limited in this disclosure.

In some embodiments, in a case where the terminal equipment autonomously activates the intermediate device, the terminal equipment may also initialize or reinitialize the configured uplink grant, and then adjust the timing of the first uplink transmission on the configured uplink grant transmitted from the terminal equipment to the network device via the intermediate device by using the first TA value. The configured uplink grant may be an uplink grant provided by RRC, or may be an uplink grant provided by a PDCCH. Contents of the configured uplink grant have been described above, which shall not be described herein any further.

In some embodiments, in a case where the terminal equipment autonomously activates the intermediate device, the terminal equipment may also recover the SRS configuration, and then adjust the timing of the first uplink transmission (SRS) corresponding to the SRS configuration transmitted from the terminal equipment to the network device via the intermediate device by using the first TA value.

In some embodiments, in a case where the terminal equipment autonomously activates the intermediate device, the terminal equipment may also recover or transmit a PUCCH, and adjust the timing of the first uplink transmission on the PUCCH transmitted from the terminal equipment to the network device via the intermediate device by using the first TA value.

The methods of the above three embodiments are illustrative only, and the three methods may be implemented separately, or may be implemented in a combined manner, which are not limited in this disclosure.

The first TA value shall be described below in detail.

In some embodiments, the first TA value is included in a radio resource control (RRC) message transmitted by the network device to the terminal equipment.

In the above embodiment, the first TA value may be included in at least one of the following configurations of the RRC message: bandwidth part (BWP) configuration, cell configuration, additional configuration (new configuration).

In some embodiments, the first TA value is included in a random access response (RAR) transmitted by the network device to the terminal equipment.

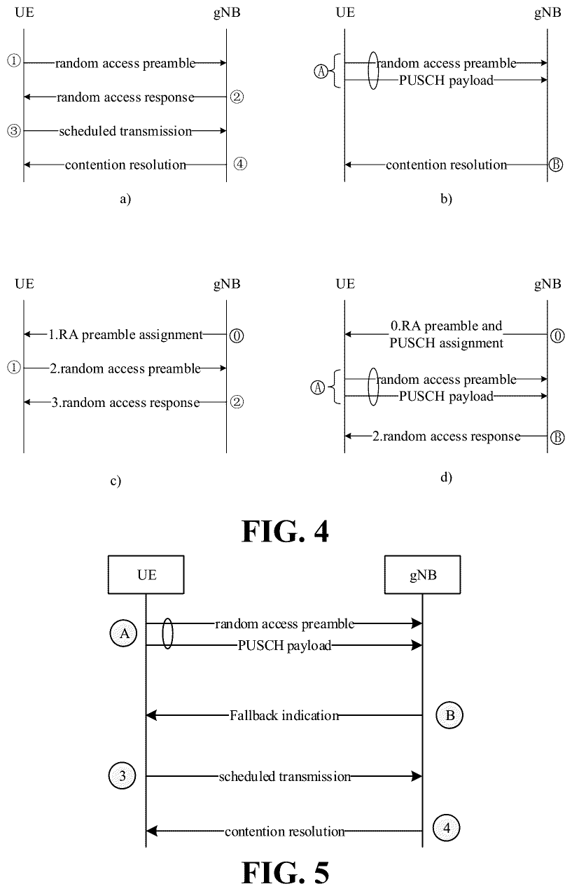

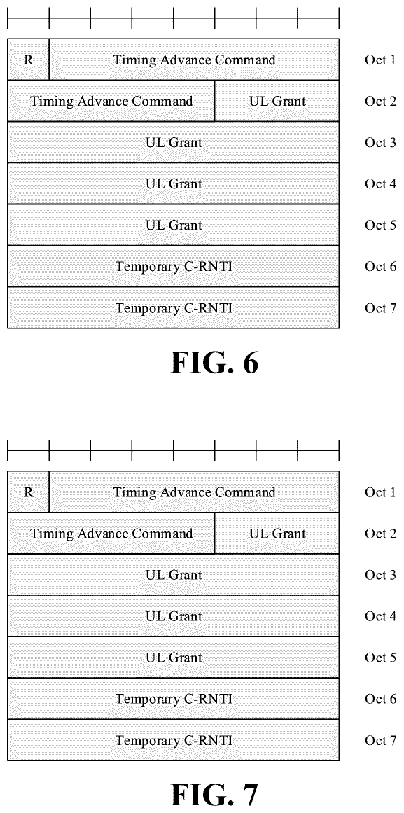

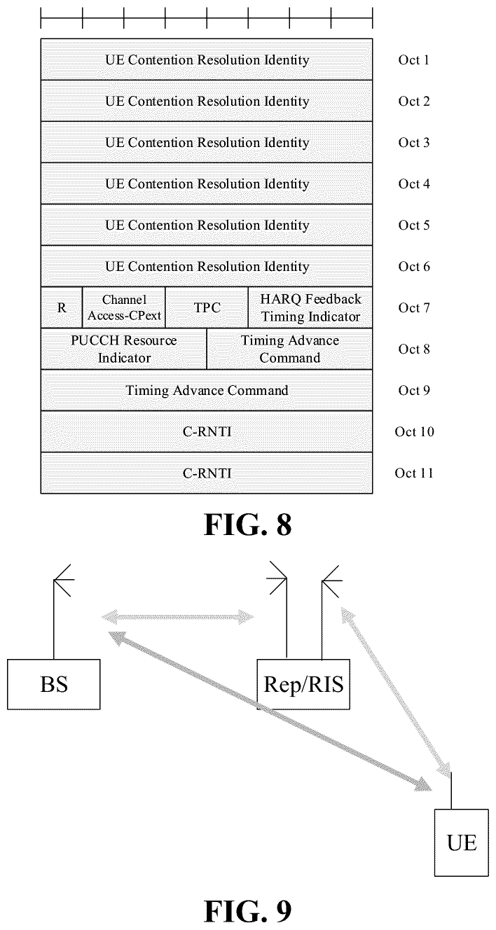

In the above embodiment, the terminal equipment may initiate a random access procedure related to the intermediate device to the network device and receive an RAR transmitted by the network device, the above first TA value being included in the RAR. For example, the above first TA value is included in MSG2, such as a payload of the random access response shown in a) and c) of FIG. 4, or the above first TA value is included in an MSGB, such as a payload of contention resolution shown in b) of FIG. 4, or a payload of the random access response shown in d) of FIG. 4.

In the above embodiment, during the random access procedure related to the intermediate device, a random access preamble may be transmitted by the terminal equipment to the network device via the intermediate device.

In the above embodiment, during the random access procedure related to the intermediate device, the random access preamble may be transmitted on a physical random access channel (PRACH) related to the intermediate device. For example, the random access preamble may be transmitted on a time-frequency resource related to the intermediate device, such a PRACH occasion; however, this disclosure is not limited thereto. In addition, the random access preamble may be related to the intermediate device; however, this disclosure is not limited thereto.

In the above embodiment, the random access response may be transmitted by the network device to the terminal equipment via the intermediate device, or, the random access response may be directly transmitted by the network device to the terminal equipment.

In some embodiments, the first TA value is included in a media access control (MAC) control element (CE) transmitted by the network device to the terminal equipment.

In the above embodiment, the first timing advance (TA) value is a relative TA value or an absolute TA value.

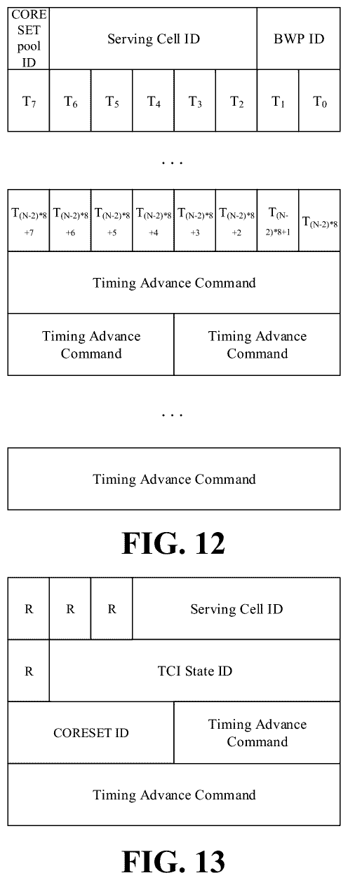

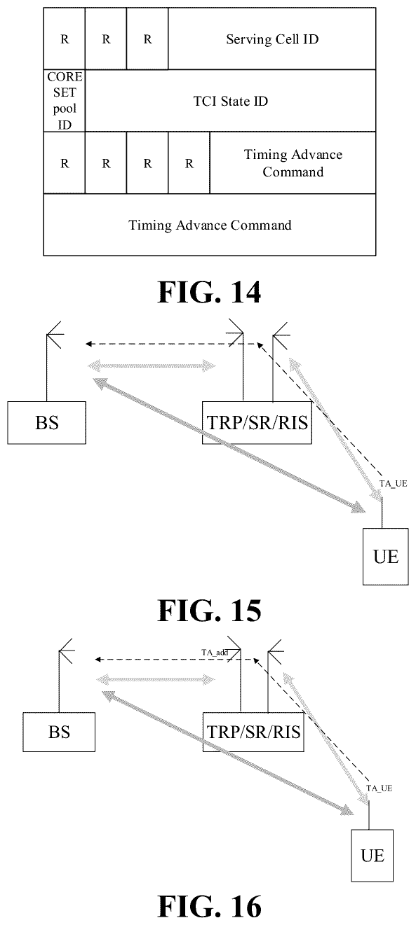

For example, the MAC CE at least includes TCI state ID information and a corresponding absolute TA value. In addition, the MAC CE may include a serving cell ID, a BWP ID, and a CORESET pool ID, as shown in FIG. 12. Or, the MAC CE may also include a serving cell ID and a CORSET ID, as shown in FIG. 13. Or, the MAC CE may also include a serving cell ID and a CORSET pool ID, as shown in FIG. 14.

For another example, the MAC CE at least includes TCI state ID information and a corresponding absolute TA value. For example, the TAC of 12 bits in FIGS. 12 to 14 are replaced with a TAC of 6 bits.

In some embodiments, the terminal equipment may also use a known TA value as the above first TA value, or set the first TA value to be 0. For example, in a case where the RRC message transmitted by the network device does not include the first TA value, the terminal equipment may take a known TA value as the first TA value, or set the first TA value to be 0.

In the above embodiment, the known TA value may be a TA value of an existing active cell or base station, or may be a TA value of an existing active intermediate device; however, this disclosure is not limited thereto.

In the above embodiment, the RRC message may be used to transmit different IEs in different TRP/SR/RIS models, which shall be described below by way of examples.

FIG. 15 is a schematic diagram of an example of a BWP-like TRP/SR/RIS model. In the example in FIG. 15, the TRP/SR/RIS are defined as additional BWPs.

For example, the TRP/SR/RIS are configured to be different BWPs, and activation/deactivation of the TRP/SR/RIS is/are achieved by a BWP switching mechanism, i.e. based on L1 signaling.

For another example, retaining the common configuration of the existing cell, that is, the terminal continues to monitor the public channels of the existing cell.

For a further example, for the TRP/SR/RIS, there is a complete set of PxxCH configurations (PUCCH/PUSCH/PDCCH/PDSCH/PRACH/PBCH) and a complete set of common and dedicated configurations.

In the above BWP-like TRP/SR/RIS model, the additional BWP configuration includes the first TA value. If the additional BWP configuration does not include the TA value, the terminal equipment may take a TA value of an existing active cell or base station, or a TA value of an existing active intermediate device, as the first TA value, or set the first TA value to be 0.

The configuration of the model in FIG. 15 reuses BWP Switching, and the mechanism is simple and mature, and may lower costs; physical configuration per TRP/SR/RIS is also allowed, and the terminal may proceed with monitoring a public channel of an existing cell, such as system information, and paging, etc. In addition, the model in FIG. 15 is applicable to a scenario where multiple TRP/SR/RIS belong to different cells.

FIG. 16 is a schematic diagram of an example of a cell-like TRP/SR/RIS model. In the example in FIG. 16, the TRP/SR/RIS is defined as an independent cell (e.g. an assisting cell).

For example, this cell is always associated with a legacy serving cell (such as a main cell) via inter-cell operations, such as inter-cell multi-TRP operations, and the two cells may share the same frequency or use different frequencies.

For another example, this cell has a C-RNTI identical to or different from that of the associated main cell.

For a further example, configuration of adding, modifying and releasing of this cell is performed via RRC signaling.

For still a further example, each legacy serving cell (a special cell or a secondary cell) may have an associated assisting cell.

For still another example, when this cell is used for uplink, an RLF shall track a signal of the cell, which may be a part of main cell RLM, or may be taken as a separate assisting cell RLM.

In the above cell-like TRP/SR/RIS model, configuration of the independent cell includes the first TA value. If the configuration of the cell does not include the TA value, the terminal equipment may take a TA value of an existing active cell or base station or a TA value of an existing active intermediate device as the above first TA value, or set the first TA value to be 0.

The configuration of the model in FIG. 16 supports separate physical configurations, and supports simultaneous transmission/reception reusing a current carrier aggregation architecture. Moreover, the model in FIG. 16 is applicable to a scenario where multiple TRP/SR/RIS belong to different cells.

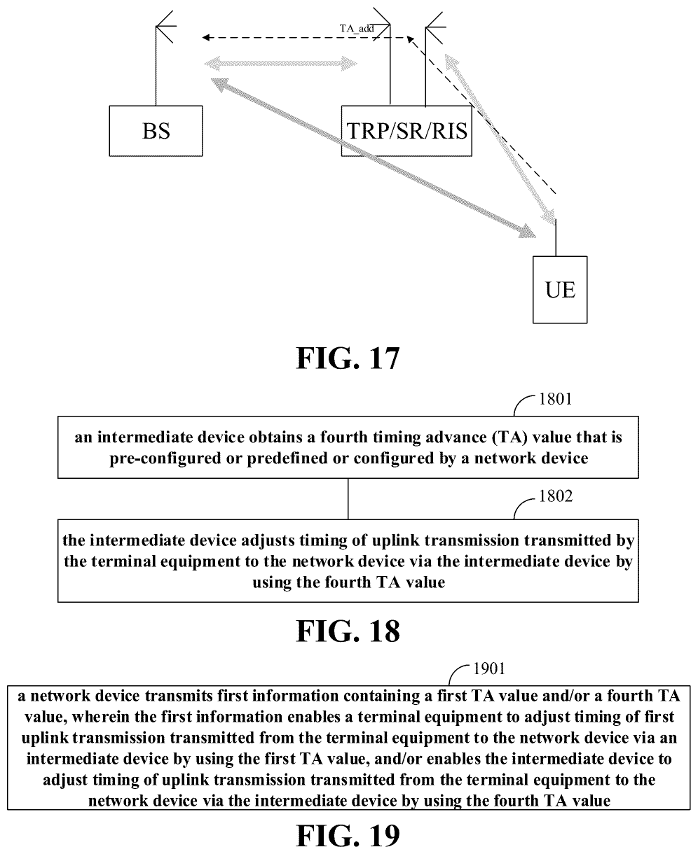

FIG. 17 is a schematic diagram of an addition config-like TRP/SR/RIS model. In the example in FIG. 17, the TRP/SR/RIS is defined as a dedicated resource for ensuring individual beams.

For example, an additional SSB group from the TRP/SR/RIS is configured in an existing serving cell configuration or a new IE (such as NonServingCellConfig) and is associated with an index, and this index (such as PCI) may be used to associate TCI states, CSI measurement configurations, possible UL configurations, etc., with this additional SSB group.

For another example, a TCI states is also configured in an existing serving cell or a new IE (such as NonServingCellConfig), and allocates SSB indices associated with different indices (such as PCI).

For a further example, CORESETPoolIndex with a value of 0 is associated with a serving cell, and CORESETPoolIndex with a value of 1 is associated with this TRP/SR/RIS.

For still another example, the TRP/SR/RIS share cell-specific parameters of an existing serving cell, or do not need cell-specific parameters. For example, the TRP/SR/RIS do not need PRACHs, and trigger RACHs via a PDCCH command if needed; and it is assumed that the existing serving cell has the same TA as the TRP/SR/RIS.

For yet another example, SSB related information of the TRP/SR/RIS is included in CSI configuration, so as to configure CSI of the TRP/SR/RIS.

For yet still another example, it is configured that SSB related information of the TRP/SR/RIS at least includes an SSB time-domain position, an SSB transmission period and SSB transmit power.

For yet further example, PCI of the TRP/SR/RIS is included in the existing serving cell configuration, or is included in a new IE, such as NonServingCellConfig.

In the addition config-like TRP/SR/RIS model, the first TA value is included in the existing serving cell configuration or a new IE (such as NonServingCellConfig). If the first TA value is not included in the existing serving cell configuration or the new IE (such as NonServingCellConfig), the terminal equipment may take a TA value of an existing activated cell or base station or a TA value of an existing activated intermediate device as the above first TA value, or set the first TA value to be 0.

The configuration of the model in FIG. 17 is simple and flexible, and may have a minimum amount of configuration signaling. Moreover, the model in FIG. 17 is applicable to a scenario where multiple TRP/SR/RIS belong to identical or different cells.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

According to the method of the embodiment of this disclosure, in the case of using operations of an additional node/device/entity, through the method and apparatus for adjusting uplink timing provided in the embodiment of this disclosure, times for uplink data from identical/different terminals that pass or do not pass the additional node/device/entity to reach the network device are identical or a time difference therebetween is tolerable, hence, the network device is able to decode successfully and diversity gains may be achieved.

### Embodiment of a Second Aspect

The embodiment of this disclosure provides a method for adjusting uplink timing, which shall be described from an intermediate device. The intermediate device may the above-described additional device/node/entity, which are collectively referred to as intermediate devices in the embodiment of this disclosure, wherein contents identical to those in the embodiment of the first aspect shall not be repeated herein any further.

FIG. 18 is a schematic diagram of the method for adjusting uplink timing of the embodiment of this disclosure. As shown in FIG. 18, the method for adjusting uplink timing of the embodiment of this disclosure includes:
1801: an intermediate device obtains a fourth timing advance (TA) value that is pre-configured or predefined or configured by a network device; and
1802: the intermediate device adjusts timing of uplink transmission transmitted by the terminal equipment to the network device via the intermediate device by using the fourth TA value.

It should be noted that FIG. 18 only schematically illustrates the embodiment of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 18.

In some embodiments, the fourth timing advance (TA) value is included in a radio resource control (RRC) message transmitted by the network device to the intermediate device. After receiving the RRC message, the intermediate device obtains the fourth TA value, and upon receiving the uplink transmission transmitted by the terminal equipment, adjusts the timing of the uplink transmission transmitted from the terminal equipment to the network device via the intermediate device by using the fourth TA value. Contents of the RRC message are similar to those of the RRC message transmitted by the network device to the terminal equipment, and reference may be made to relevant techniques for details, which shall not be repeated herein any further.

In some embodiments, the fourth timing advance (TA) value is included in a random access response (RAR). The RAR is transmitted by the network device to the intermediate device, and after receiving the RAR, the intermediate device obtains the fourth TA value, and upon receiving the uplink transmission transmitted by the terminal equipment, adjusts the timing of the uplink transmission transmitted from the terminal equipment to the network device via the intermediate device by using the fourth TA value. Contents of the RAR message are similar to those of the RRC message transmitted by the network device to the terminal equipment, and reference may be made to relevant techniques for details, which shall not be repeated herein any further.

In some embodiments, the fourth timing advance (TA) value is included in a media access control (MAC) control element (CE) transmitted by the network device to the intermediate device. After receiving the MAC CE, the intermediate device obtains the fourth TA value, and upon receiving the uplink transmission transmitted by the terminal equipment, adjusts the timing of the uplink transmission transmitted from the terminal equipment to the network device via the intermediate device by using the fourth TA value.

In the above embodiment, the fourth timing advance (TA) value is a relative TA value or an absolute TA value. In addition, the media access control (MAC) control element (CE) further includes a transmission configuration indication (TCI) state identifier and/or a control resource set pool identifier. Contents of the MAC CE are similar to those of the MAC CE transmitted by the network device to the terminal equipment, and reference may be made to relevant techniques for details, which shall not be repeated herein any further.

In some embodiments, the intermediate device may take a known TA value as the fourth timing advance (TA) value, or set the fourth timing advance (TA) value to be 0. For example, in a case where the fourth timing advance (TA) value is not included in the radio resource control (RRC) message transmitted by the network device, the intermediate device may take a known TA value as the fourth timing advance (TA) value, or set the fourth timing advance (TA) value to be 0. The known TA value has been described in the embodiment of the first aspect, which shall not be repeated herein any further.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

According to the method of the embodiment of this disclosure, in the case of using operations of an additional node/device/entity, in the method and apparatus for adjusting uplink timing provided in the embodiment of this disclosure, times for uplink data from identical/different terminals that pass or do not pass the additional node/device/entity to reach the network device are identical or a time difference therebetween is tolerable, hence, the additional node/device/entity is able to perform signal processing successfully and transmit the signals to the network device, thereby achieving uplink coverage enhancement.

Adjusting, by the terminal equipment, the timing of the uplink transmission transmitted from the terminal equipment to the network device via the intermediate device by using the obtained first TA value is described in the embodiment of the first aspect, and adjusting, by the intermediate device, the timing of the uplink transmission transmitted from the terminal equipment to the network device via the intermediate device by using the obtained fourth TA value is described in the embodiment of the second aspect. The above two aspects of embodiments may be implemented separately or in a combined manner, that is, the terminal equipment adjusts the timing of the uplink transmission transmitted from the terminal equipment to the network device via the intermediate device by using the obtained first TA value, while the intermediate device adjusts the timing of the uplink transmission transmitted from the terminal equipment to the network device via the intermediate device by using the obtained fourth TA value.

### Embodiment of a Third Aspect

The embodiment of this disclosure provides a method for adjusting uplink timing, which shall be described from a network device. This method is processing at a network device side corresponding to the embodiment of first aspect and/or the embodiment of the second aspect, with contents identical to those in the embodiment of first aspect and the embodiment of the second aspect being not going to be described herein any further.

FIG. 19 is a schematic diagram of the method for adjusting uplink timing of the embodiment of this disclosure. As shown in FIG. 19, the method for adjusting uplink timing of the embodiment of this disclosure includes:
1901: a network device transmits first information containing a first TA value and/or a fourth TA value, wherein the first information enables a terminal equipment to adjust timing of first uplink transmission transmitted from the terminal equipment to the network device via an intermediate device by using the first TA value, and/or enables the intermediate device to adjust timing of uplink transmission transmitted from the terminal equipment to the network device via the intermediate device by using the fourth TA value.

In some embodiments, the network device further transmits second information containing a second TA value, wherein the second information enables the terminal equipment to adjust timing of uplink transmission transmitted directly from the terminal equipment to the network device without via the intermediate device by using the second TA value.

In some embodiments, the network device further transmits an activation indication for activating the intermediate device to the terminal equipment. After the network device activates the intermediate device, the terminal equipment adjusts the timing of the first uplink transmission transmitted from the terminal equipment to the network device via the intermediate device by using the first TA value. The first uplink transmission is, for example, an SRS, or a PUCCH. Contents of the activation indication have been described in the embodiment of the first aspect, which shall not be described herein any further.

In the above embodiment, the network device may further transmit a scheduling indication for the first uplink transmission to the terminal equipment. After the network device activates the intermediate device and after receiving the scheduling indication, the terminal equipment adjusts the timing of the first uplink transmission transmitted from the terminal equipment to the network device via the intermediate device by using the first TA value.

In some embodiments, the network device further transmits a scheduling indication for the first uplink transmission to the terminal equipment. After receiving the scheduling indication, the terminal equipment adjusts the timing of the first uplink transmission transmitted from the terminal equipment to the network device via the intermediate device (in an active state) by using the first TA value, or, after receiving the scheduling indication, the terminal equipment activates the intermediate device, and adjusts the timing of the first uplink transmission transmitted from the terminal equipment to the network device via the intermediate device by using the first TA value.

The first uplink transmission is, for example, PUSCH transmission. Contents of the scheduling indication have been described in the embodiment of the first aspect, which shall not be described herein any further.

In some embodiments, the network device further transmits an RRC message to the terminal equipment and/or the intermediate device, wherein the RRC message includes the above first TA value and/or the fourth TA value. Contents of the RRC message have been described in the embodiment of the first aspect and the embodiment of the second aspect, which shall not be described herein any further.

In some embodiments, the network device may further provide random access resources and/or preamble configuration information related to the intermediate device for the terminal equipment, and/or transmit a random access response to the terminal equipment or to the terminal equipment via the intermediate device during the random access procedure. Contents related to the random access have been described in the embodiment of the first aspect, which shall not be described herein any further.

In the above embodiment, the network device may transmit the random access response to the intermediate device during the random access procedure, and the fourth TA value is included in the random access response.

In some embodiments, the network device may further transmit an MAC CE to the terminal equipment and/or the intermediate device, wherein the MAC CE includes the above first TA value and/or second TA value. Contents of the MAC CE have been described in the embodiment of the first aspect and the embodiment of the second aspect, which shall not be described herein any further.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

According to the method of the embodiment of this disclosure, in the case of using operations of an additional node/device/entity, in the method and apparatus for adjusting uplink timing provided in the embodiment of this disclosure, times for uplink data from identical/different terminals to reach the additional node/device/entity are identical or a time difference therebetween is tolerable, hence, the additional node/device/entity is able to perform signal processing successfully and transmit the signals to the network device, thereby achieving uplink coverage enhancement.

### Embodiment of a Fourth Aspect

The embodiment of this disclosure provides an apparatus for adjusting uplink timing. The apparatus may be, for example, a terminal equipment, or one or some components or assemblies configured in the terminal equipment, with contents identical to those in the embodiment of the first aspect being not going to be described herein any further.

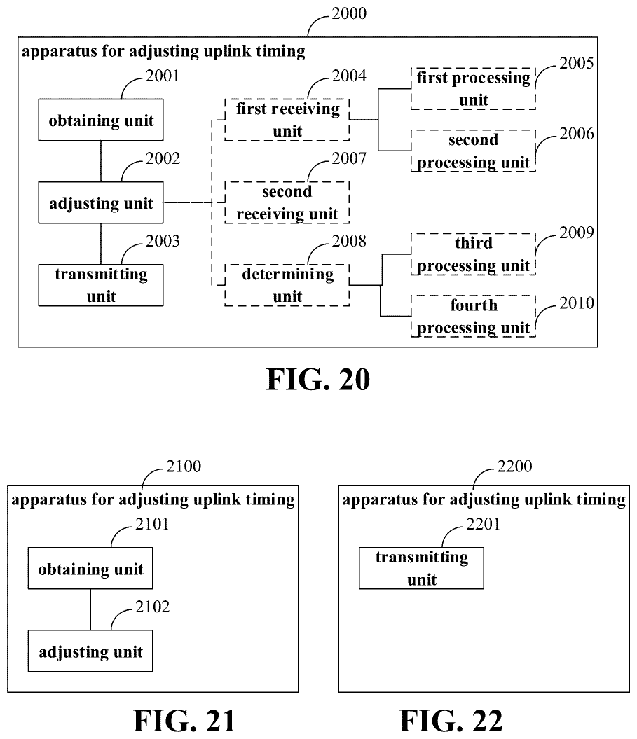

FIG. 20 is a schematic diagram of the apparatus for adjusting uplink timing of the embodiment of this disclosure. As shown in FIG. 20, the apparatus 2000 for adjusting uplink timing includes:
an obtaining unit 2001 configured to obtain a first timing advance (TA) value that is pre-configured or predefined or configured by a network device; and
an adjusting unit 2002 configured to adjust timing of first uplink transmission transmitted by the terminal equipment to the network device via an intermediate device by using the first TA value.

In some embodiments, the obtaining unit 2001 further obtains a second timing advance (TA) value that is pre-configured or predefined or configured by the network device, and the adjusting unit 2002 further adjusts timing of second uplink transmission transmitted by the terminal equipment to the network device by using the second TA value.

In some embodiments, as shown in FIG. 20, the apparatus 2000 for adjusting uplink timing further includes:
a transmitting unit 2003 configured to transmit the first uplink transmission based on the first timing advance (TA) value, the first uplink transmission being forwarded by the intermediate device to the network device based on the third TA value.

In some embodiments, the intermediate device is configured with a third timing advance (TA) value by the network device, the transmitting unit 2003 transmits the first uplink transmission based on the first timing advance (TA) value, and the first uplink transmission is transmitted by the intermediate device to the network device based on the third timing advance (TA) value.

In some embodiments, as shown in FIG. 20, the apparatus 2000 for adjusting uplink timing further includes:
a first receiving unit 2004 configured to receive an activation indication for activating the intermediate device transmitted by the network device.

In the above embodiment, the activation indication is downlink control information (DCI), or a media access control (MAC) control element (CE); and the activation indication includes transmission configuration indication (TCI) state identifier and/or a control resource set pool identifier to which the intermediate device corresponds.

In the above embodiment, in one implementation, the first receiving unit 2004 may further receive a scheduling indication for scheduling the first uplink transmission transmitted by the network device, and upon receiving the scheduling indication, the adjusting unit 2002 adjusts the timing of the first uplink transmission transmitted from the terminal equipment to the network device via the intermediate device by using the first timing advance value.

In the above embodiment, in another implementation, as shown in FIG. 20, the apparatus 2000 for adjusting uplink timing further includes:
a first processing unit 2005 configured to initialize or reinitialize a configured uplink grant when the intermediate device is activated; and after the configured uplink grant is initialized or reinitialized, the adjusting unit 2002 adjusts the timing of the first uplink transmission on the configured uplink grant transmitted from the terminal equipment to the network device via the intermediate device by using the first timing advance value; wherein the configured uplink grant is an uplink grant provided by RRC, or an uplink grant provided by a PDCCH.

In the above embodiment, in some implementations, as shown in FIG. 20, the apparatus 2000 further includes:
a second processing unit 2006 configured to recover SRS configuration, and/or recover or transmit a PUCCH, when the intermediate device is activated; and after the SRS configuration is recovered and/or the PUCCH is recovered or transmitted, the adjusting unit 2002 adjusts the timing of the first uplink transmission (SRS) to which the SRS configuration corresponds and/or the first uplink transmission on the PUCCH transmitted from the terminal equipment to the network device via the intermediate device by using the first timing advance value.

In some embodiments, as shown in FIG. 20, the apparatus 2000 for adjusting uplink timing further includes:
a second receiving unit 2007 configured to receive a scheduling indication for scheduling the first uplink transmission transmitted by the network device; and when the scheduling indication is received, the adjusting unit 2002 adjusts the timing of the first uplink transmission transmitted by the terminal equipment to the network device via the intermediate device by using the first timing advance value.

In the above embodiment, the scheduling indication is downlink control information (DCI), and the scheduling indication includes a transmission configuration indication (TCI) state identifier and/or a control resource set pool identifier to which the intermediate device corresponds.

In some embodiments, as shown in FIG. 20, the apparatus 2000 for adjusting uplink timing further includes:
a determining unit 2008 configured to determine whether to activate the intermediate device; and when the intermediate device is activated, the adjusting unit 2002 adjusts the timing of the first uplink transmission transmitted by the terminal equipment to the network device via the intermediate device by using the first timing advance value.

In the above embodiment, the determining unit 2008 determines whether to activate the intermediate device based on a downlink reference signal from the network device and/or a downlink reference signal from the network device via the intermediate device and/or a measurement result of a downlink reference signal from the intermediate device, and/or the determining unit 2008 determines whether to activate the intermediate device based on a result of beam failure detection between the terminal equipment and the network device or based on whether to trigger beam failure recovery between the terminal equipment and the network device.

In the above embodiment, in one implementation, as shown in FIG. 20, the apparatus 2000 further includes:
a third processing unit 2009 configured to initialize or reinitialize a configured uplink grant when the intermediate device is activated; and after the configured uplink grant is initialized or reinitialized, the adjusting unit 2002 adjusts the timing of the first uplink transmission on the configured uplink grant transmitted by the terminal equipment to the network device via the intermediate device by using the first timing advance value; wherein the configured uplink grant is an uplink grant provided by RRC, or an uplink grant provided by a PDCCH.

In the above embodiment, in another implementation, as shown in FIG. 20, the apparatus 2000 further includes:
a fourth processing unit 2010 configured to recover SRS configuration, and/or recover or transmit a PUCCH when the intermediate device is activated, and after the SRS configuration is recovered, and/or, the PUCCH is recovered or transmitted, the adjusting unit 2002 adjusts the timing of the first uplink transmission to which the SRS configuration corresponds and/or the timing of the first uplink transmission on the PUCCH transmitted by the terminal equipment to the network device via the intermediate device by using the first timing advance value.

In some embodiments, the first timing advance (TA) value is included in a radio resource control (RRC) message transmitted by the network device to the terminal equipment.

In the above embodiment, the first timing advance (TA) value is included in at least one of the following configurations of the radio resource control (RRC) message: a bandwidth part (BWP) configuration, a cell configuration, and an additional configuration.

In some embodiments, the first timing advance (TA) value is included in a random access response (RAR) transmitted by the network device.

In the above embodiment, the obtaining unit 2001 initiates to the network device a random access procedure related to the intermediate device, and receives a random access response (RAR) transmitted by the network device, the first timing advance value being included in the random access response.

In the above embodiment, in the random access procedure related to the intermediate device, a random access preamble is transmitted by the terminal equipment to the network device via the intermediate device.

In the above embodiment, in the random access procedure related to the intermediate device, in an example, a random access preamble is transmitted on a physical random access channel (PRACH) related to the intermediate device, and in another example, a random access preamble is related to the intermediate device.

In the above embodiment, the random access response is transmitted by the network device to the terminal equipment via the intermediate device, or, the random access response is transmitted directly by the network device to the terminal equipment.

In some embodiments, the first timing advance (TA) value is included in a media access control (MAC) control element (CE) transmitted by the network device to the terminal equipment.

In the above embodiment, the first timing advance (TA) value is a relative TA value or an absolute TA value, and the media access control (MAC) control element (CE) further includes a transmission configuration indication (TCI) state identifier and/or a control resource set pool identifier.

In some embodiments, the obtaining unit 2001 takes a known TA value as the first timing advance (TA) value, or sets the first timing advance (TA) value to be 0. For example, if the first timing advance (TA) value is not included in the radio resource control (RRC) message transmitted by the network device, the obtaining unit 1001 takes a known TA value as the first timing advance (TA) value, or sets the first timing advance (TA) value to be 0.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

It should be noted that the components or modules related to this disclosure are only described above. However, this disclosure is not limited thereto, and the apparatus 2000 for adjusting uplink timing may further include other components or modules, and reference may be made to related techniques for particulars of these components or modules.

Furthermore, for the sake of simplicity, connection relationships between the components or modules or signal profiles thereof are only illustrated in FIG. 20. However, it should be understood by those skilled in the art that such related techniques as bus connection, etc., may be adopted.

And the above components or modules may be implemented by hardware, such as a processor, a memory, a transmitter, and a receiver, etc., which are not limited in the embodiment of this disclosure.

According to the apparatus of the embodiment of this disclosure, in the case of using operations of an additional node/device/entity, in the method and apparatus for adjusting uplink timing provided in the embodiment of this disclosure, times for uplink data from identical/different terminals that pass or do not pass the additional node/device/entity to reach the network device are identical or a time difference therebetween is tolerable, hence, the network device is able to decode successfully and diversity gains may be achieved.

### Embodiment of a Fifth Aspect

The embodiment of this disclosure provides an apparatus for adjusting uplink timing. The apparatus may be, for example, an intermediate device, or one or some components or assemblies configured in the intermediate device, with contents identical to those in the embodiments of the first and second aspects being not going to be described herein any further.

FIG. 21 is a schematic diagram of the apparatus for adjusting uplink timing of the embodiment of this disclosure. As shown in FIG. 21, the apparatus 2100 for adjusting uplink timing includes:
an obtaining unit 2101 configured to obtain a fourth timing advance (TA) value that is pre-configured or predefined or configured by a network device; and
an adjusting unit 2102 configured to, upon receiving uplink transmission transmitted by a terminal equipment, adjust timing of uplink transmission transmitted by the terminal equipment to the network device via the intermediate device by using the fourth TA value.

In some embodiments, the fourth timing advance (TA) value is included in a radio resource control (RRC) message transmitted by the network device to the intermediate device.

In some embodiments, the fourth timing advance (TA) value is included in a random access response (RAR) transmitted by the network device to terminal equipment via the intermediate device.

In some embodiments, the fourth timing advance (TA) value is included in a media access control (MAC) control element (CE) transmitted by the network device to the intermediate device.

In the above embodiment, the fourth timing advance (TA) value is a relative TA value or an absolute TA value, and the media access control (MAC) control element (CE) further includes a transmission configuration indication (TCI) state identifier and/or a control resource set pool identifier.

In some embodiments, the obtaining unit 2101 takes a known TA value as the fourth timing advance (TA) value, or sets the fourth timing advance (TA) value to be 0. For example, in a case where the fourth timing advance (TA) value is not included in the radio resource control (RRC) message transmitted by the network device, the obtaining unit 2101 takes a known TA value as the fourth timing advance (TA) value, or sets the fourth timing advance (TA) value to be 0.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

It should be noted that the components or modules related to this disclosure are only described above. However, this disclosure is not limited thereto, and the apparatus 2100 for adjusting uplink timing may further include other components or modules, and reference may be made to related techniques for particulars of these components or modules.

Furthermore, for the sake of simplicity, connection relationships between the components or modules or signal profiles thereof are only illustrated in FIG. 21. However, it should be understood by those skilled in the art that such related techniques as bus connection, etc., may be adopted.

And the above components or modules may be implemented by hardware, such as a processor, a memory, a transmitter, and a receiver, etc., which are not limited in the embodiment of this disclosure.

According to the apparatus of the embodiment of this disclosure, in the case of using operations of an additional node/device/entity, in the method and apparatus for adjusting uplink timing provided in the embodiment of this disclosure, times for uplink data from identical/different terminals that pass or do not pass the additional node/device/entity to reach the network device are identical or a time difference therebetween is tolerable, hence, the network device is able to decode successfully and diversity gains may be achieved.

### Embodiment of a Sixth Aspect

The embodiment of this disclosure provides an apparatus for adjusting uplink timing. The apparatus may be, for example, a network device, with contents identical to those in the embodiments of the first and second aspects being not going to be described herein any further.

FIG. 22 is a schematic diagram of the apparatus for adjusting uplink timing of the embodiment of this disclosure. As shown in FIG. 22, the apparatus 2200 for adjusting uplink timing includes:
a transmitting unit 2201 configured to transmit first information including a first TA value and/or a fourth TA value, the first information enabling a terminal equipment to, by using the first TA value, adjust timing of first uplink transmission transmitted by the terminal equipment to the network device via an intermediate device, and/or enabling the intermediate device to, by using the fourth TA value, adjust timing of uplink transmission transmitted by the terminal equipment to the network device via the intermediate device.

In some embodiments, the transmitting unit 2201 further transmits second information containing a second TA value, wherein the second information enables the terminal equipment to adjust timing of uplink transmission transmitted directly from the terminal equipment to the network device without via the intermediate device by using the second TA value.

In some embodiments, the transmitting unit 2201 further transmits an activation indication for activating the intermediate device to the terminal equipment. After the network device activates the intermediate device, the terminal equipment adjusts the timing of the first uplink transmission transmitted from the terminal equipment to the network device via the intermediate device by using the first TA value.

In the above embodiment, in one implementation, the transmitting unit 2201 further transmits a scheduling indication for the first uplink transmission to the terminal equipment. After the network device activates the intermediate device and after receiving the scheduling indication, the terminal equipment adjusts the timing of the first uplink transmission transmitted from the terminal equipment to the network device via the intermediate device by using the first TA value.

In some embodiments, the transmitting unit 2201 further transmits a scheduling indication for the first uplink transmission to the terminal equipment. After receiving the scheduling indication, the terminal equipment adjusts the timing of the first uplink transmission transmitted from the terminal equipment to the network device via the intermediate device by using the first TA value, or, after receiving the scheduling indication, the terminal equipment activates the intermediate device, and adjusts the timing of the first uplink transmission transmitted from the terminal equipment to the network device via the intermediate device by using the first TA value.

In some embodiments, the transmitting unit 2201 further transmits an RRC message to the terminal equipment and/or the intermediate device, wherein the RRC message includes the first TA value and/or the fourth TA value.

In some embodiments, the transmitting unit 2201 further provides random access resources and/or preamble configuration information related to the intermediate device for the terminal equipment, and/or transmits a random access response to the terminal equipment or to the terminal equipment via the intermediate device during the random access procedure.

In some embodiments, the transmitting unit 2201 further transmits a random access response to the intermediate device during the random access procedure, and the fourth TA value is included in the random access response.

In some embodiments, the transmitting unit 2201 further transmits an MAC CE to the terminal equipment and/or the intermediate device, wherein the MAC CE includes the first TA value and/or second TA value.

The above embodiments only illustrate the embodiment of this disclosure. However, this disclosure is not limited thereto, and appropriate variants may be made on the basis of these embodiments. For example, the above embodiments may be executed separately, or one or more of them may be executed in a combined manner.

It should be noted that the components or modules related to this disclosure are only described above. However, this disclosure is not limited thereto, and the apparatus 2200 for adjusting uplink timing may further include other components or modules, and reference may be made to related techniques for particulars of these components or modules.

Furthermore, for the sake of simplicity, connection relationships between the components or modules or signal profiles thereof are only illustrated in FIG. 22. However, it should be understood by those skilled in the art that such related techniques as bus connection, etc., may be adopted.

And the above components or modules may be implemented by hardware, such as a processor, a memory, a transmitter, and a receiver, etc., which are not limited in the embodiment of this disclosure.

According to the apparatus of the embodiment of this disclosure, in the case of using operations of an additional node/device/entity, in the method and apparatus for adjusting uplink timing provided in the embodiment of this disclosure, times for uplink data from identical/different terminals that pass or do not pass the additional node/device/entity to reach the network device are identical or a time difference therebetween is tolerable, hence, the network device is able to decode successfully and diversity gains may be achieved.

### Embodiment of a Seventh Aspect

The embodiment of this disclosure provides a communication system.

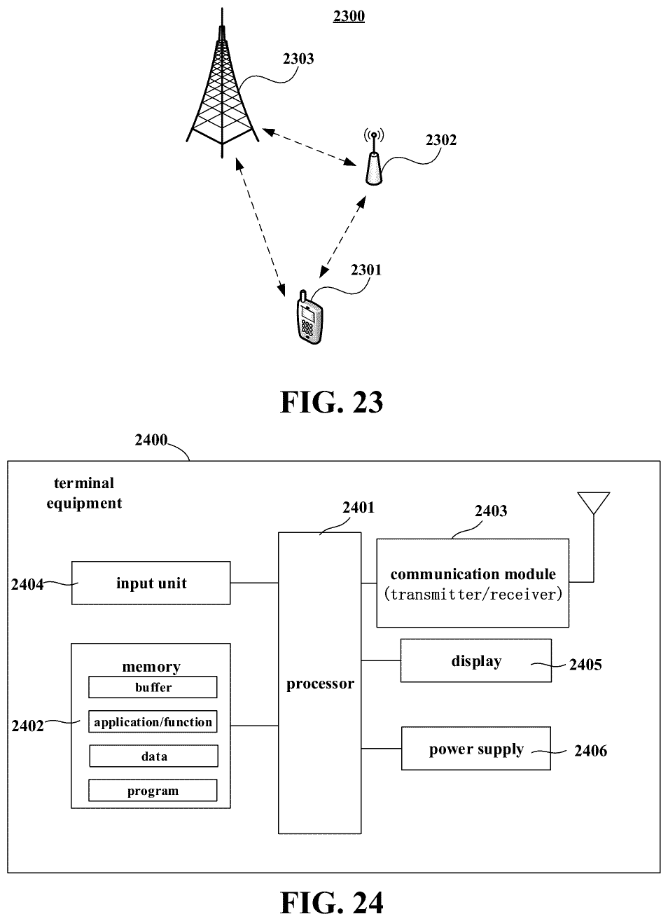

FIG. 23 is a schematic diagram of the communication system 2300 of the embodiment of this disclosure.

In some embodiments, as shown in FIG. 23, the communication system 2300 may include a terminal equipment 2301, an intermediate device 2302 and a network device 2303.

In the embodiment of this disclosure, the terminal equipment 2301 obtains a first timing advance (TA) value that is pre-configured or predefined or configured by the network device 2303, and adjusts timing of first uplink transmission transmitted by the terminal equipment 1201 to the network device 2303 via the intermediate device (node/entity) 2302 by using the first timing advance value; and/or the intermediate device 2302 obtains a fourth timing advance (TA) value that is pre-configured or predefined or configured by the network device 2303, and adjusts timing of uplink transmission transmitted by the terminal equipment 2301 to the network device 2303 via the intermediate device 2302 by using the fourth timing advance value; and/or the network device 2303 transmits first information containing the first TA value and/or the fourth TA value, wherein the first information enables the terminal equipment 2301 to adjust timing of first uplink transmission transmitted from the terminal equipment 2301 to the network device 2303 via the intermediate device 2302 by using the first TA value, and/or enables the intermediate device 2302 to adjust timing of uplink transmission transmitted from the terminal equipment 2301 to the network device 2303 via the intermediate device 2302 by using the fourth TA value.

Reference may be made to the embodiments of the first to third aspects for contents related to the terminal equipment 2301, the intermediate device 2302 and network device 2303, which shall not be repeated herein any further.

The embodiment of this disclosure further provides a terminal equipment.

FIG. 24 is a schematic diagram of the terminal equipment of the embodiment of this disclosure. As shown in FIG. 24, the terminal equipment 2400 may include a processor 2401 and a memory 2402, the memory 2402 storing data and a program, and being coupled to the processor 2401. It should be noted that this figure is illustrative only, and other types of structures may also be used, so as to supplement or replace this structure and achieve a telecommunications function or other functions.

For example, the processor 2401 may be configured to execute a program to carry out the method as described in the embodiment of the first aspect.

As shown in FIG. 24, the terminal equipment 2400 may further include a communication module 2403, an input unit 2404, a display 2405, and a power supply 2406; wherein functions of the above components are similar to those in the related art, which shall not be described herein any further. It should be noted that the terminal equipment 2400 does not necessarily include all the parts shown in FIG. 24, and the above components are not necessary. Furthermore, the terminal equipment 2400 may include parts not shown in FIG. 24, and the related art may be referred to.

The embodiment of this disclosure further provides an intermediate device, which may be, for example, the additional node/device/entity as described above.

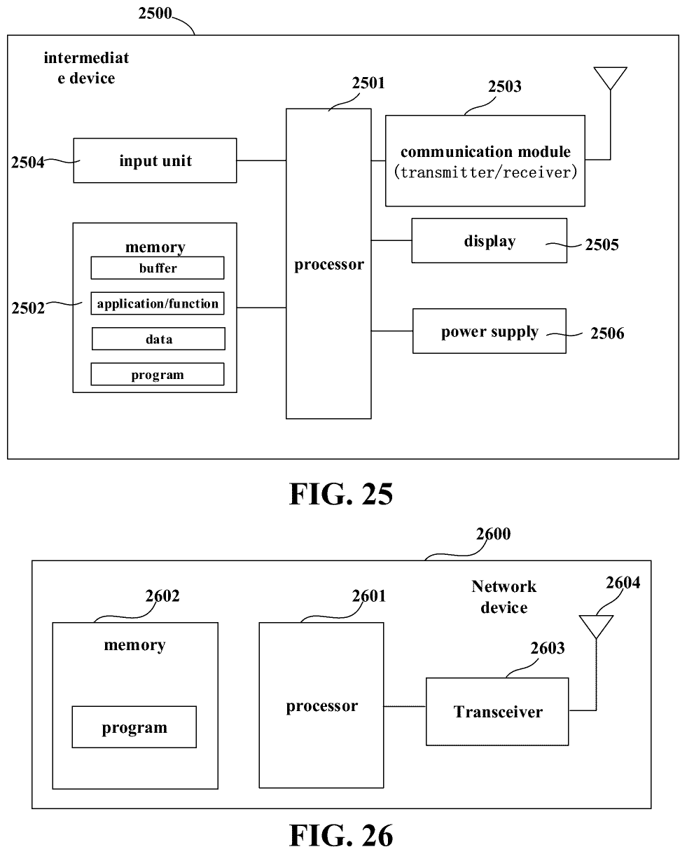

FIG. 25 is a schematic diagram of the intermediate device of the embodiment of this disclosure. As shown in FIG. 25, the intermediate device 2500 may include a processor 2501 and a memory 2502, the memory 2502 storing data and a program, and being coupled to the processor 2501. It should be noted that this figure is illustrative only, and other types of structures may also be used, so as to supplement or replace this structure and achieve a telecommunications function or other functions.

For example, the processor 2501 may be configured to execute a program to carry out the method as described in the embodiment of the second aspect.

As shown in FIG. 25, the intermediate device 2500 may further include communication module 2503, an input unit 2504, a display 2505, and a power supply 2506; wherein functions of the above components are similar to those in the related art, which shall not be described herein any further. It should be noted that the intermediate device 2500 does not necessarily include all the parts shown in FIG. 25, and the above components are not necessary. Furthermore, the intermediate device 2500 may include parts not shown in FIG. 25, and the related art may be referred to.

The embodiment of this disclosure further provides a network device.

FIG. 26 is a schematic diagram of the network device of the embodiment of this disclosure. As shown in FIG. 26, the network device 2600 may include a processor (such as a central processing unit (CPU)) 2601 and a memory 2602, the memory 2602 being coupled to the processor 2601. The memory 2602 may store various data, and furthermore, it may store a program for information processing, and execute the program under control of the processor 2601, so as to receive various information transmitted by a terminal equipment and transmit various information to the terminal equipment.

For example, the processor 2601 may be configured to execute a program to carry out the method described in the embodiment of the third aspect.

Furthermore, as shown in FIG. 26, the network device 2600 may include a transceiver 2603, and an antenna 2604, etc. Functions of the above components are similar to those in the related art, and shall not be described herein any further. It should be noted that the network device 2600 does not necessarily include all the parts shown in FIG. 26, and furthermore, the network device 2600 may include parts not shown in FIG. 26, and the related art may be referred to.

An embodiment of this disclosure provides a computer readable program, which, when executed in a terminal equipment, will cause the terminal equipment to carry out the method as described in the embodiment of the first aspect.

An embodiment of this disclosure provides a storage medium storing a computer readable program, which will cause a terminal equipment to carry out the information feedback method as described in the embodiment of the first aspect.

An embodiment of this disclosure provides a computer readable program, which, when executed in an intermediate device, will cause the intermediate device to carry out the method as described in the embodiment of the second aspect.

An embodiment of this disclosure provides a storage medium storing a computer readable program, which will cause an intermediate device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.
1. A method for adjusting uplink timing, including:
obtaining, by a terminal equipment, a first timing advance (TA) value that is pre-configured or predefined or configured by a network device; and
adjusting, by the terminal equipment, timing of first uplink transmission transmitted by the terminal equipment to the network device via an intermediate device by using the first timing advance value.
2. The method according to supplement 1, wherein the method further includes:
obtaining, by the terminal equipment, a second timing advance (TA) value that is pre-configured or predefined or configured by the network device; and
adjusting, by the terminal equipment, timing of second uplink transmission transmitted by the terminal equipment to the network device by using the second timing advance value.
3. The method according to supplement 1 or 2, wherein the terminal equipment transmits the first uplink transmission based on the first timing advance (TA) value, and the first uplink transmission is forwarded by the intermediate device to the network device.
4. The method according to supplement 1 or 2, wherein the intermediate device is configured with a third timing advance (TA) value by the network device, and the terminal equipment transmits the first uplink transmission based on the first timing advance (TA) value, and the first uplink transmission is transmitted by the intermediate device to the network device based on the third timing advance (TA) value.
5. The method according to any one of supplements 1-4, wherein the method further includes:
   receiving, by the terminal equipment, an activation indication for activating the intermediate device transmitted by the network device.
6. The method according to supplement 5, wherein the activation indication is downlink control information (DCI) and/or a media access control (MAC) control element (CE), and the activation indication includes a transmission configuration indication (TCI) state identifier and/or a control resource set pool identifier to which the intermediate device corresponds.
7. The method according to supplement 5 or 6, wherein the method further includes:
   receiving, by the terminal equipment, a scheduling indication for scheduling the first uplink transmission transmitted by the network device; and
upon receiving the scheduling indication, adjusting, by the terminal equipment, the timing of the first uplink transmission transmitted from the terminal equipment to the network device via the intermediate device (node/entity) by using the first timing advance value.
7a. The method according to supplement 5 or 6, wherein the method further includes:
initializing or reinitializing a configured uplink grant by the terminal equipment; and
adjusting, by the terminal equipment, the timing of the first uplink transmission on the configured uplink grant transmitted from the terminal equipment to the network device via the intermediate device (node/entity) by using the first timing advance value.
7aa. The method according to supplement 7a, wherein,
the configured uplink grant is an uplink grant provided by RRC, or an uplink grant provided by a PDCCH.
7b. The method according to supplement 5 or 6, wherein the method further includes:
recovering the SRS configuration, and/or, recovering or transmitting a PUCCH, by the terminal equipment; and
adjusting, by the terminal equipment, the timing of the first uplink transmission (SRS) corresponding to the SRS configuration and/or the first uplink transmission on the PUCCH transmitted from the terminal equipment to the network device via the intermediate device (node/entity) by using the first timing advance value.
8. The method according to any one of supplements 1-4, wherein the method further includes:
receiving, by the terminal equipment, a scheduling indication for scheduling the first uplink transmission transmitted by the network device; and
upon receiving the scheduling indication, adjusting, by the terminal equipment, the timing of the first uplink transmission transmitted from the terminal equipment to the network device via the intermediate device (node/entity) by using the first timing advance value.
9. The method according to supplement 8, wherein the scheduling indication is downlink control information (DCI);
and the scheduling indication includes a transmission configuration indication (TCI) state identifier and/or a control resource set pool identifier to which the intermediate device corresponds.
10. The method according to any one of supplements 1-4, wherein the method further includes:
determining by the terminal equipment whether to activate the intermediate device; and
when the intermediate device is activated, adjusting, by the terminal equipment, the timing of the first uplink transmission transmitted from the terminal equipment to the network device via the intermediate device (node/entity) by using the first timing advance value.
11. The method according to supplement 10, wherein the terminal equipment determines whether to activate the intermediate device based on measurement results of a downlink reference signal from the network device and/or a downlink reference signal from the network device via the intermediate device and/or a downlink reference signal from the intermediate device, and/or, the terminal equipment determines whether to activate the intermediate device based on a result of beam failure detection between it and the network device or based on whether to trigger beam failure recovery between it and the network device.
11a. The method according to supplement 10 or 11, wherein the method further includes:
initializing or reinitializing the configured uplink grant by the terminal equipment; and
adjusting, by the terminal equipment, the timing of the first uplink transmission on the configured uplink grant transmitted from the terminal equipment to the network device via the intermediate device (node/entity) by using the first timing advance value.
11aa. The method according to supplement 11a, wherein,
the configured uplink grant is an uplink grant provided by RRC, or is an uplink grant provided by a PDCCH.
11b. The method according to supplement 10 or 11, wherein the method further includes:
recovering the SRS configuration, and/or, recovering or transmitting a PUCCH, by the terminal equipment; and
adjusting, by the terminal equipment, the timing of the first uplink transmission (SRS) corresponding to the SRS configuration and/or the first uplink transmission on the PUCCH transmitted from the terminal equipment to the network device via the intermediate device (node/entity) by using the first timing advance value.
12. The method according to any one of supplements 1-11, wherein the first timing advance (TA) value is included in a radio resource control (RRC) message transmitted by the network device to the terminal equipment.
13. The method according to any one of supplements 1-11, wherein in a case where the radio resource control (RRC) message transmitted by the network device does not include the first timing advance (TA) value, the terminal equipment takes a known TA value as the first timing advance (TA) value, or set the first timing advance (TA) value to be 0.
14. The method according to supplement 12, wherein the first timing advance (TA) value is included in at least one of the following configurations of the radio resource control (RRC) message: bandwidth part (BWP) configuration, cell configuration, additional configuration.
15. The method according to any one of supplements 1-11, wherein the method further includes:
initiating a random access procedure related to the intermediate device by the terminal equipment to the network device; and
receiving a random access response (RAR) transmitted by the network device, the first timing advance (TA) value being included in the random access response.
16. The method according to supplement 15, wherein during the random access procedure related to the intermediate device, a random access preamble is transmitted by the terminal equipment to the network device via the intermediate device.
17. The method according to supplement 15 or 16, wherein during the random access procedure related to the intermediate device, the random access preamble is transmitted on a physical random access channel (PRACH) related to the intermediate device, or the random access preamble is related to the intermediate device.
18. The method according to any one of supplements 15-17, wherein the random access response is transmitted by the network device to the terminal equipment via the intermediate device, or, the random access response is transmitted by the network device to the terminal equipment.
19. The method according to any one of supplements 1-11, wherein the first timing advance (TA) value is included in a media access control (MAC) control element (CE) transmitted by the network device to the terminal equipment.
20. The method according to supplement 19, wherein the first timing advance (TA) value is a relative TA value or an absolute TA value, and the MAC CE further includes a transmission configuration indication (TCI) state identifier and/or a control resource set pool identifier.
21. A method for adjusting uplink timing, including:
obtaining, by an intermediate device (node/entity), a fourth timing advance (TA) value that is pre-configured or predefined or configured by a network device; and
adjusting, by the intermediate device, timing of uplink transmission transmitted by the terminal equipment to the network device via the intermediate device by using the fourth timing advance value upon receiving the uplink transmission transmitted by the terminal equipment.
22. The method according to supplement 21, wherein the fourth timing advance (TA) value is included in a radio resource control (RRC) message transmitted by the network device to the intermediate device.
23. The method according to supplement 21 or 22, wherein in a case where the fourth timing advance (TA) value is not included in the radio resource control (RRC) message transmitted by the network device, the terminal equipment takes a known TA value as the fourth timing advance (TA) value, or sets the fourth timing advance (TA) value to be 0.
24. The method according to supplement 21, wherein the fourth timing advance (TA) value is included in a random access response (RAR).
25. The method according to supplement 21, wherein the fourth timing advance (TA) value is included in a media access control (MAC) control element (CE) transmitted by the network device to the intermediate device.
26. The method according to supplement 25, wherein the fourth timing advance (TA) value is a relative TA value or an absolute TA value, and the media access control (MAC) control element (CE) further includes a transmission configuration indication (TCI) state identifier and/or a control resource set pool identifier.
27. A method for adjusting uplink timing, including:
transmitting first information containing a first TA value and/or a fourth TA value by the network device, wherein the first information enables a terminal equipment to adjust timing of first uplink transmission transmitted from the terminal equipment to the network device via an intermediate device by using the first TA value, and/or enables the intermediate device to adjust timing of uplink transmission transmitted from the terminal equipment to the network device via the intermediate device by using the fourth TA value.
28. The method according to supplement 27, wherein the method further includes:
transmitting second information containing a second TA value by the network device, the second information enables the terminal equipment to adjust timing of uplink transmission transmitted directly from the terminal equipment to the network device without via the intermediate device by using the second TA value.
29. The method according to supplement 27, wherein the method further includes:
transmitting an activation indication for activating the intermediate device by the network device to the terminal equipment, and after the network device activates the intermediate device, adjusting, by the terminal equipment, the timing of the first uplink transmission transmitted from the terminal equipment to the network device via the intermediate device by using the first TA value.
30. The method according to supplement 27, wherein the method further includes:
transmitting a scheduling indication for the first uplink transmission by the network device to the terminal equipment; and
after receiving the scheduling indication, the terminal equipment adjusts the timing of the first uplink transmission transmitted from the terminal equipment to the network device via the intermediate device by using the first TA value, or, after receiving the scheduling indication, the terminal equipment activates the intermediate device and adjust the timing of the first uplink transmission transmitted from the terminal equipment to the network device via the intermediate device by using the first TA value.
30a. The method according to supplement 29, wherein the method further includes:
transmitting a scheduling indication for the first uplink transmission by the network device to the terminal equipment after the network device activates the intermediate device and after the terminal equipment receives the scheduling indication, the terminal equipment adjusts the timing of the first uplink transmission transmitted from the terminal equipment to the network device via the intermediate device by using the first TA value.
31. The method according to supplement 27, wherein the method further includes:
transmitting an RRC message by the network device to the terminal equipment and/or the intermediate device, wherein the RRC message includes the first TA value and/or the fourth TA value.
32. The method according to supplement 27, wherein the method further includes:
providing random access resources and/or preamble configuration information related to the intermediate device by the network device for the terminal equipment, and/or transmitting, by the network device, a random access response to the terminal equipment or to the terminal equipment via the intermediate device during the random access procedure.
33. The method according to supplement 27, wherein the method further includes:
transmitting a random access response to the intermediate device by the network device during the random access procedure, the fourth TA value being included in the random access response.
34. The method according to supplement 27, wherein the method further includes:
transmitting an MAC CE by the network device to the terminal equipment and/or the intermediate device, wherein the MAC CE includes the first TA value and/or second TA value.
35. A terminal equipment, including a memory and a processor, the memory storing a computer program, and the processor being configured to execute the computer program to carry out the method as described in any one of supplements 1-20.
36. An intermediate device, including a memory and a processor, the memory storing a computer program, and the processor being configured to execute the computer program to carry out the method as described in any one of supplements 21-26.
37. A network device, including a memory and a processor, the memory storing a computer program, and the processor being configured to execute the computer program to carry out the method as described in any one of supplements 27-34.
38. A communication system, including a terminal equipment, an intermediate device and a network device, wherein,
the terminal equipment obtains a first timing advance (TA) value that is pre-configured or predefined or configured by the network device, and adjusts timing of first uplink transmission transmitted by the terminal equipment to the network device via the intermediate device by using the first timing advance value;
and/or the intermediate device obtains a fourth timing advance (TA) value that is pre-configured or predefined or configured by the network device, and when uplink transmission transmitted by the terminal equipment is received, adjusts timing of the uplink transmission transmitted by the terminal equipment to the network device via the intermediate device by using the fourth timing advance value;
and/or the network device transmits first information including a first TA value and/or a fourth TA value, the first information enabling the terminal equipment to, by using the first TA value, adjust timing of first uplink transmission transmitted by the terminal equipment to the network device via the intermediate device, and/or enabling the intermediate device to, by using the fourth TA value, adjust timing of uplink transmission transmitted by the terminal equipment to the network device via the intermediate device.

1. An apparatus for adjusting uplink timing, configured in a terminal equipment, characterized in that the apparatus comprising:
an obtaining unit configured to obtain a first timing advance (TA) value and a second TA value which are pre-configured or predefined or configured by a network device; and
an adjusting unit configured to adjust timing of first uplink transmission by using the first TA value and timing of second uplink transmission by using the second TA value, the first uplink transmission being transmitted by the terminal equipment to the network device via an intermediate device which includes TRP (Transmit/Receive Point) under inter-cell and intra-cell multi-DCI (Downlink Control Information) multi-TRP operation, and the second uplink transmission being transmitted by the terminal equipment to the network device.

2. The apparatus according to claim 1, wherein,
the first uplink transmission and the second uplink transmission respectively include one or any combination of PUCCH, PUSCH, and SRS.

3. The apparatus according to claim 1, wherein the intermediate device is configured with a third timing advance (TA) value by the network device, and the apparatus further comprises:
a transmitting unit configured to transmit the first uplink transmission based on the first timing advance (TA) value, the first uplink transmission being transmitted by the intermediate device to the network device based on the third timing advance (TA) value.

4. The apparatus according to claim 1, wherein the apparatus further comprises:
a first receiving unit configured to receive an activation indication for activating the intermediate device transmitted by the network device.

5. The apparatus according to claim 4, wherein,
the first receiving unit further receives a scheduling indication for scheduling the first uplink transmission transmitted by the network device; and
when the scheduling indication is received, the adjusting unit, by using the first timing advance value, adjusts the timing of the first uplink transmission transmitted by the terminal equipment to the network device via the intermediate device.

6. The apparatus according to claim 4, wherein the apparatus further comprises:
a first processing unit configured to initialize or reinitialize a configured uplink grant;
and the adjusting unit, by using the first timing advance value, adjusts the timing of the first uplink transmission on the configured uplink grant, the first uplink transmission being transmitted by the terminal equipment to the network device via the intermediate device.

7. The apparatus according to claim 4, wherein the apparatus further comprises:
a second processing unit configured to recover SRS configuration, and/or recover or transmit a PUCCH;
and the adjusting unit, by using the first timing advance value, adjusts the timing of the first uplink transmission to which the SRS configuration corresponds and/or the timing of the first uplink transmission on the PUCCH, the first uplink transmission being transmitted by the terminal equipment to the network device via the intermediate device.

8. The apparatus according to claim 1, wherein the apparatus further comprises:
a second receiving unit configured to receive a scheduling indication for scheduling the first uplink transmission, the scheduling indication being transmitted by the network device;
and when the scheduling indication is received, the adjusting unit, by using the first timing advance value, adjusts the timing of the first uplink transmission transmitted by the terminal equipment to the network device via the intermediate device.

9. The apparatus according to claim 1, wherein the apparatus further comprises:
a determining unit configured to determine whether to activate the intermediate device;
and when the intermediate device is activated, the adjusting unit, by using the first timing advance value, adjusts the timing of the first uplink transmission transmitted by the terminal equipment to the network device via the intermediate device.

10. The apparatus according to claim 9, wherein the determining unit determines whether to activate the intermediate device based on a measurement result of a downlink reference signal from the network device and/or a downlink reference signal from the network device via the intermediate device and/or a downlink reference signal from the intermediate device, and/or the determining unit determines whether to activate the intermediate device based on a result of beam failure detection between the terminal equipment and the network device or based on whether to trigger beam failure recovery between the terminal equipment and the network device.

11. The apparatus according to claim 9, wherein the apparatus further comprises:
a third processing unit configured to initialize or reinitialize a configured uplink grant;
and the adjusting unit, by using the first timing advance value, adjusts the timing of the first uplink transmission on the configured uplink grant, the first uplink transmission being transmitted by the terminal equipment to the network device via the intermediate device.

12. The apparatus according to claim 9, wherein the apparatus further comprises:
a fourth processing unit configured to recover SRS configuration, and/or recover or transmit a PUCCH;
and the adjusting unit, by using the first timing advance value, adjusts the timing of the first uplink transmission to which the SRS configuration corresponds and/or the timing of the first uplink transmission on the PUCCH, the first uplink transmission being transmitted by the terminal equipment to the network device via the intermediate device.

13. The apparatus according to claim 1, wherein the first timing advance (TA) value is included in a radio resource control (RRC) message transmitted by the network device to the terminal equipment.

14. The apparatus according to claim 13, wherein the first timing advance (TA) value is included in at least one of the following configurations of the radio resource control (RRC) message: a bandwidth part (BWP) configuration, a cell configuration, and an additional configuration.

15. The apparatus according to claim 1, wherein,
the obtaining unit initiates to the network device a random access procedure related to the intermediate device, and receives a random access response (RAR) transmitted by the network device, the first timing advance (TA) value being included in the random access response.

16. The apparatus according to claim 15, wherein in the random access procedure related to the intermediate device, a random access preamble is transmitted on a physical random access channel (PRACH) related to the intermediate device, and/or, a random access preamble is related to the intermediate device.

17. The apparatus according to claim 1, wherein the first timing advance (TA) value is included in a media access control (MAC) control element (CE) transmitted by the network device to the terminal equipment.

18. The apparatus according to claim 17, wherein the first timing advance (TA) value is a relative TA value or an absolute TA value, and the media access control (MAC) control element (CE) further includes a transmission configuration indication (TCI) state identifier and/or a control resource set pool identifier.

19. An activation apparatus, configured in a terminal equipment, characterized in that the apparatus comprising:
a processor configured to:
obtain a first TA value which is pre-configured or predefined or configured by a network device, and
adjust timing of first uplink transmission by using the first TA value, the first uplink transmission being transmitted by the terminal equipment to the network device via an intermediate device which includes TRP under inter-cell and intra-cell multi-DCI multi-TRP operation; and
a receiver configured to receive an activation indication transmitted by the network device, the activation indication including transmission configuration indication (TCI) state ID and/or control resource pool identifier (CORSET pool ID) corresponding to the intermediate device.

20. A communication system, comprising:
a terminal equipment;
an intermediate device includes TRP under inter-cell and intra-cell multi-DCI multi-TRP operation; and
a network device, wherein,
the terminal equipment is configured to:
obtain a first timing advance (TA) value and a second TA value which are pre-configured or predefined or configured by the network device, and adjust timing of first uplink transmission by using the first TA value and timing of second uplink transmission by using the second TA value, the first uplink transmission being transmitted by the terminal equipment to the network device via the intermediate device, and the second uplink transmission being transmitted by the terminal equipment to the network device; and/or
obtain a first TA value which is pre-configured or predefined or configured by a network device, adjust timing of first uplink transmission by using the first TA value, the first uplink transmission being transmitted by the terminal equipment to the network device via an intermediate device, and receive an activation indication transmitted by the network device, the activation indication including transmission configuration indication (TCI) state ID and/or control resource pool identifier (CORSET pool ID) corresponding to the intermediate device.
